(19) United States
(12) Patent Application Publication
(10) Pub. No.: US 2017/0364295 A1
(43) Pub. Date: Dec. 21, 2017

(54) Method and Apparatus for Providing Memory Storage Using Small Form-Factor Pluggable ("SFP") Auxiliary Plug

(71) Applicants: Bernie Sardinha, Gilroy, CA (US); Shakti Yogesh Shah, San Jose, CA (US); Ross Stenfort, Los Altos, CA (US)

(72) Inventors: Bernie Sardinha, Gilroy, CA (US); Shakti Yogesh Shah, San Jose, CA (US); Ross Stenfort, Los Altos, CA (US)

(73) Assignee: CNEX Labs, Inc, San Jose, CA (US)

(21) Appl. No.: 15/623,259

(22) Filed: Jun. 14, 2017

Related U.S. Application Data
(60) Provisional application No. 62/350,606, filed on Jun. 15, 2016.

(51) Int. Cl. G06F 3/06; G06F 1/26

(52) U.S. Cl. CPC G06F 3/0625; G06F 3/0688; G06F 1/266; G06F 3/0617; G06F 3/0655

(57) ABSTRACT

A method or system capable of providing additional storage capacity using small form-factor (“SFP”) non-volatile memory (“NVM”) solid state drive (“SSD”) with modular to modular configuration is disclosed. A system includes a processing device, SFP auxiliary plug (“SAP”), and power SAP. In one embodiment, the processing device includes multiple SFP sockets operable to provide data communication. The SAP, having a SSD connector and an auxiliary connector, facilitates storing information persistently via NVM. The SSD connector of SAP is used for communicating with the processing device when the SAP is plugged into one of the SFP sockets. The power SAP, having a power connector and a power extension connector, is capable of providing electrical power to the SAP when the power extension connector and the auxiliary connector are coupled or connected.

### PRIORITY

This application claims the benefit of priority based upon U.S. Provisional Patent Application having an application Ser. No. 62/350,606, filed on Jun. 15, 2016, and having a title of “Method and Apparatus for Providing Small Form-Factor Pluggable (“SFP”) Auxiliary Plugs,” which is hereby incorporated by reference in its entirety.

### FIELD

The exemplary embodiment(s) of the present invention relates to the field of storage for digital computing systems. More specifically, the exemplary embodiment(s) of the present invention relates to non-volatile memory (“NVM”) storage devices.

### BACKGROUND

With increasing popularity of electronic devices, such as computers, smart phones, mobile devices, server farms, mainframe computers, and the like, the demand for more and faster data is constantly growing. To handle and facilitate voluminous data between such electronic devices, NVM devices are typically required. A conventional type of NVM device, for example, is a flash memory based storage device such as solid-state drive (“SSD”).

One conventional type of NVM SSD is flash memory based SSD which, for example, can be used for an electronic NVM storage capable of maintaining, erasing, and/or reprogramming data. The flash memory can be fabricated with several different types of integrated circuit (“IC”) technologies such as NOR or NAND logic gates with, for example, floating-gate transistors. Depending on the applications, the access to data stored in flash memory can be configured to be units of blocks, pages, words, and/or bytes.

A drawback associated with a typical flash based SSD is that it has structural limitations, limited port configuration, connectivity difficulties, limited power availability, as well as interface limitations.

### SUMMARY

A method or system capable of providing additional storage capacity using small form-factor (“SFP”) non-volatile memory (“NVM”) solid state drive (“SSD”) with modular to modular configuration is disclosed. A system includes a processing device, SFP auxiliary plug (“SAP”), and power SAP. In one embodiment, the processing device includes multiple SFP sockets operable to provide data communication. The SAP, having a SSD connector and an auxiliary connector, facilitates storing information persistently via NVM. The SSD connector of SAP is used for communicating with the processing device when the SAP is plugged into one of the SFP sockets. The power SAP, having a power connector and a power extension connector, is capable of providing electrical power to the SAP when the power extension connector and the auxiliary connector are coupled or connected.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating SFP NVM SSD (“SNS”) plug configured to provide external storage space to a digital processing system via a standard coupling connector in accordance with one embodiment of the present invention;

FIGS. 2A-2B are block diagrams illustrating several exemplarily SNS plugs containing various modules in accordance with one embodiment of the present invention;

FIG. 3 is a diagram illustrating a physical layout of printed circuit board (“PCB”) for an SNS plug in accordance with one embodiment of the present invention;

FIG. 4 is a block diagram illustrating a memory configuration for NVM within the SNS plug in accordance with one embodiment of the present invention;

FIG. 5 is a logic block diagram illustrating an access to NVM storage space in an SNS plug using flash translation layer (“FTL”) in accordance with one embodiment of the present invention;

FIG. 6 illustrates an SNS plug showing several structural diagrams with an SFP and/or QSFP physical configuration in accordance with one embodiment of the present invention;

FIG. 7 is a block diagram illustrating physical layouts of SFP or QSFP auxiliary plug(s) capable of being coupled to a second plug via plug-to-plug or module-to-module linkages in accordance with one embodiment of the present invention;

FIGS. 8A-8B illustrate an alternative configuration to connect SFP or QSFP modules and auxiliary plug(s) to enhance NVM storage performance in accordance with one embodiment of the present invention;

FIG. 9 illustrates an exemplary storage device using a different connector capable of coupling to an SFP auxiliary plug (“SAP”) for power or storage enhancement in accordance with one embodiment of the present invention;

FIG. 10 illustrates diagrams showing an alternative configuration using multiple-connected SAP module in accordance with one embodiment of the present invention;

FIG. 11 is a block diagram illustrating a processing device or computer system which can be used as memory controller or network system in accordance with one embodiment of the present invention; and

FIG. 12 is a flowchart illustrating a process of memory access to an SAP plug in accordance with one embodiment of the present invention.

### DETAILED DESCRIPTION

Embodiments of the present invention are described herein with context of a method and/or apparatus for providing memory storage using small form-factor pluggable (“SFP”) non-volatile memory (“NVM”) solid state drive (“SSD”) capable of adapting module-to-module linkage.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

One embodiment of the present invention discloses a method or apparatus for configuring or fabricating non-volatile memory (“NVM”) solid state drive (“SSD”) into a small form-factor pluggable (“SFP”) or quad small form-factor pluggable (“QSFP”) memory device. With various existing SFPs and/or QSFP used in switches/routers for network communication, SSD type of storage device can be directly plugged into SFP or QSFP sockets existed in switches and routers. To operate SFP NVM SSD (“SNS”) device, one or more SNS or SFP auxiliary plugs (“SAP”), in one embodiment, are used to facilitate and enhance the capability as well as performance of the device. For example, a network system can be configured to employ one or more SAPs to enhance efficiency of storage capacity offered in a network switch. A network switch which may contain multiple SFP sockets capable of housing one or more SNS devices. Note that each SNS device or SAP contains an Ethernet protocol, a first SSD connector, and a second SSD connector.

It should be noted that the terms “SNS device” and “SAP” are synonymous referring approximately the same device or plug. The terms “SAP” and “SNS plug” can be used interchangeably for the forgoing description.

An SSD with an Ethernet protocol can be configured and/or fabricated in a small form factor such as SFP/QSFP form-factor whereby it can be directly plugged into a network switch fabric for providing multi-terabytes storage space. Depending on the applications, any types of volatile or nonvolatile media such as NAND Flash, DRAM, RRAM, MRAM, and the like can be used. Alternatively, a fixture of NVM devices such as NAND Flash, DRAM, RRAM, MRAM, and phase-changing memory (“PCM”) devices may be plugged into the switch, router, and/or modem. For example, a 10 or 40 gigabits per second (“Gb/s”) standard Ethernet port in a switch may be used for hosting a terabyte SSD using NVM_OE.

In one aspect, one embodiment of the presently claimed invention discloses a mechanism of linking multiple SAPs or SNS plugs together via module-to-module (“MOM”) or plug-to-plug (“POP”) linkage. SAP or SNS plug is a non-volatile SSD fabricated into a small form factor such as SFP or QSFP. With various existing SFPs and/or QSFP ports at switches/routers for network communication, an SAP or SSD type of storage device pluggable to SFP or QSFP ports can be advantageous because such configuration can save space, power consumption, and complexity.

The network system can be a switch or router capable of hosting an SAP or SAPs to expend its storage capacity. Note that each SAP or SFP NVM SSD storage device contains Ethernet protocol, SSD connector, and auxiliary connector.

In one embodiment, a system includes a processing device, SAP, and power SAP, wherein the processing device further includes multiple SFP sockets operable to provide data communication. SAP includes an SSD connector and auxiliary connector and is able to store information persistently via NVM. The SSD connector of SAP is used for communicating with the processing device when the SAP is plugged into one of the SFP sockets. The power SAP, having a power connector and a power extension connector, is capable of providing electrical power to SAP when the power extension connector of power SAP and the auxiliary connector of SAP are coupled or connected.

In operation, upon inserting an SNS plug or SAP into an SFP socket which is capable of facilitating optical communication at a host system, a handshaking process between the host system and the SNS plug, for example, is initiated using an Ethernet based protocol. After activating an NVM internal bus connecting to NVM array to reboot NVM storage blocks, the host system is allowed to see external memory space at the SNS plug.

During operation, a first SSD connector is plugged into one of SFP sockets of the network switch and provides additional storage capacity to the switch. The SFP auxiliary plug, containing a first connector, and a second connector, is inserted or plugged into one of the SFP sockets for providing auxiliary functions, such as, but not limited to, power supply, storage capacity, storage control, and the like. In one example, the first connector draws power from the network switch and the second connector supplies power to a connected SFP NVM SSD storage device. The SFP auxiliary plug can also be used for providing additional storage space when it is coupled with an SFP NVM SSD storage device or network switch. Moreover, the SFP auxiliary plug can also be used for providing memory control, NVM storage management, and the like.

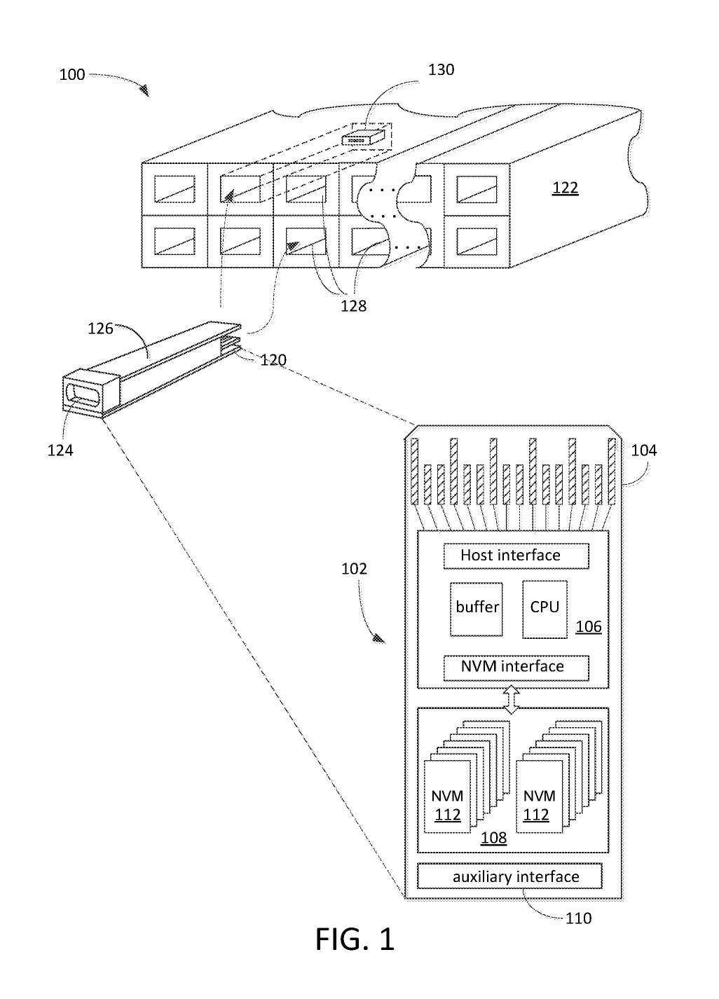

FIG. 1 is a block diagram 100 illustrating an SAP or SNS plug capable of providing external storage space to a digital processing system via a standard coupling connector in accordance with one embodiment of the present invention. Diagram 100 includes a digital processing system 122 and SAP or SNS plug 126 wherein digital processing system 122, in one example, can be a server, host, network router, network switch, base station, computer, mainframe computer, and the like. A function of digital processing system 122 is capable of executing instructions, storing data, and transmitting information via a network. It should be noted that the underlying concept of the exemplary embodiment(s) of the present invention would not change if one or more blocks (or devices) were added to or removed from diagram 100.

Digital processing system 122, in one example, is a network router which includes multiple ports 128 used for network communications. The network router, for example, includes a group of ports physically configured in small form factor sockets such as SFP or QSFP sockets. Each SFP socket, for instance, includes a connector 130 which is used to electrically couple to connector of a plug. A function of SFP socket, in one example, is to facilitate electrical data storage as well as optical data communication with optical transceiver.

The SFP format is generally relating to small size pluggable transceiver used for data communications. It should be noted that the form factor and electrical interface are standard defined by a multi-source agreement (“MSA”) under the SFF (small form factor) committee. An application of such SFP is to facilitate network communication between optical data and electrical data. For instance, SFP transceivers support various communication methods, such as, but not limited to, SONET, gigabit Ethernet, Fibre Channel, and other communications standards.

SNS plug or SAP 126, in one embodiment, has a front side 120 and back side 124 wherein front side 120 and back side 124 are connected by a printed circuit board (“PCB”) 102. PCB 102, in one aspect, includes a connector 104, memory controller 106, NVM 108, and auxiliary interface or auxiliary connector 110. While connector 104 is used to couple to socket connector or socket contact 130, memory controller 106, also known as controller, includes a host interface module, CPU, buffer, and NVM interface. NVM 108, in one example, includes one or more NVM dies having a storage range from 64 GB to 128 TB. Auxiliary interface 110, in one aspect, is used to provide extended storage capacity. Alternatively, auxiliary interface 110 can also be used to couple to a second SFP plug, secondary power supply, or optical SFP transceiver.

In operation, SNS plug 126 can be inserted into any one of SFP sockets 128 at digital processing system 122 wherein front side 120 of SFP plug 126 enters an SFP socket 128 to reach connector 130. After handshaking initialization between SNS plug 126 and digital processing system 122, digital processing system 122 can access NVM 108 via SNS plug 126. In one example, digital processing system 122 views SNS plug or SAP 126 as a high-speed external storage memory for data storage.

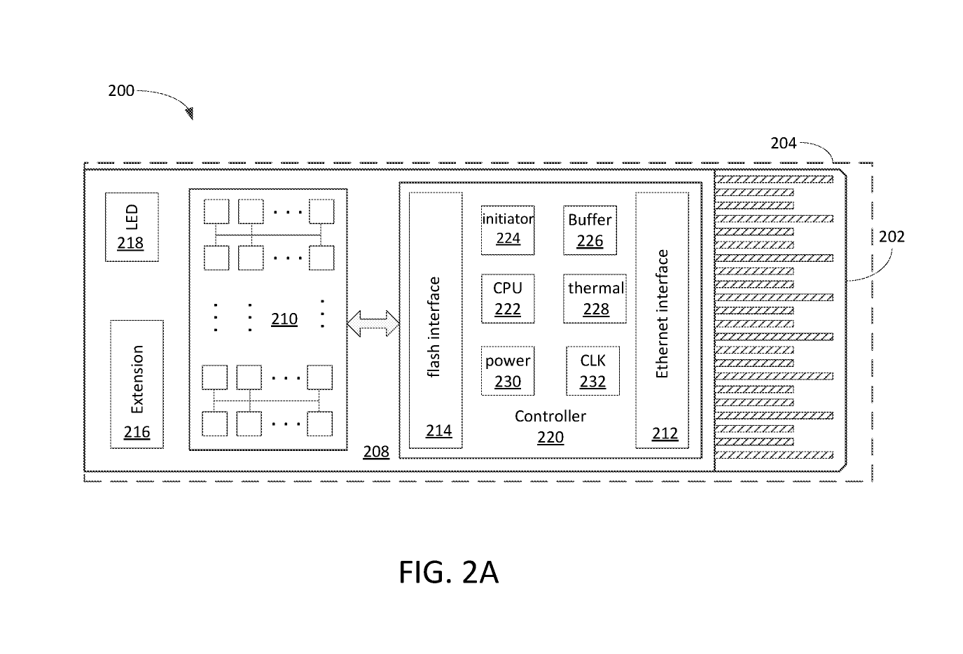

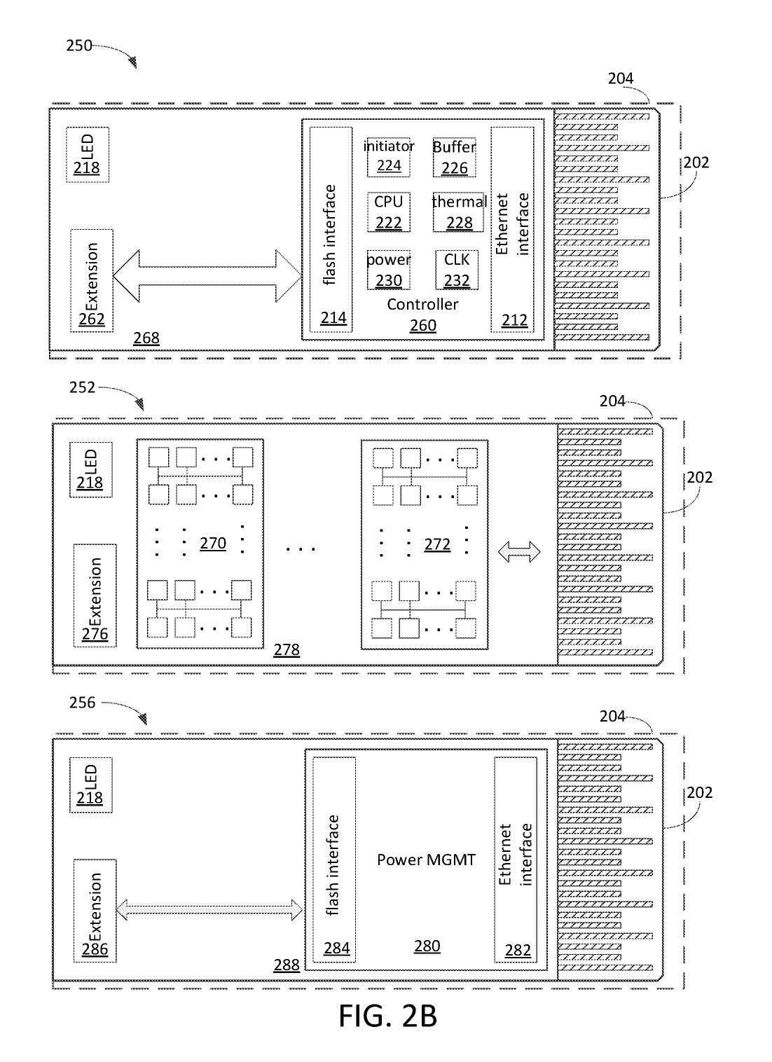

FIG. 2A is a block diagram 200 illustrating an SNS plug or SAP containing various modules in accordance with one embodiment of the present invention. Diagram 200 includes a housing 204 and PCB 208 wherein PCB 208 further includes an SFP connector 202, memory controller 220, and NVM or NVM array 210. A function of housing 204 is to house SNS plug or SAP while dissipating heat generated by the SNS plug. It should be noted that the underlying concept of the exemplary embodiment(s) of the present invention would not change if one or more blocks (or modules) were added to or removed from diagram 200.

SFP connector 202, in one embodiment, is physically configured so that it can be inserted or plugged into an SFP socket of a digital processing system such as a network router. SFP connector 202, for example, includes multiple pins configured to provide electrical connection to a host computer when the SNS plug is inserted into the SFP socket of host computer. A host computer, for example, can be a switching router containing multiple ports wherein some of these ports are configured to SFP configurations. It should be noted that a network system such as router may contain multiple SFP ports used for optical communication.

SFP connector 202 includes one or more power pins that are used to draw power from the SFP socket of a host for power supply. In one example, the host or digital processing system, which can be a network router, network switch, networking hub, computer, server, or a cluster of routers, switches, hubs, and servers, provides power to SNS plug or SAP via its SFP ports. It should be noted that SFP connector 202 can also be configured to comply with QSFP or XSFP (10 Gigabit SFP) configurations or specifications. A benefit of using an SNS plug or SAP is that it can be directly plugged into an existing SFP or QSFP sockets at a switch or router whereby it takes up minimum space while provides substantial amount of storage capacity.

Controller or memory controller 220, in one aspect, includes multiple modules, such as, but not limited, Ethernet interface 212, flash interface 214, CPU (central processing unit) 222, initiator 224, buffer 226, thermal module 228, power module 230, and clock module 232. A function of memory controller 220 is to manage and facilitate data transmission between NVM 210 and a connected host via connector 202. To facilitate memory management, controller 220, in one embodiment, uses a translation layer such as flash translation layer (“FTL”) to manage and control data access to and from NVM 210.

Ethernet interface 212, also known as host interface or interface module, includes one or more input output (“IO”) modules used for facilitating data transmission between a host and NVM chip(s). For instance, Ethernet interface 212 is able to facilitate high-speed data transfer between a host and NVM dies using Ethernet based protocol such as NVMoE™ (NVM over Ethernet) protocol. Flash interface 214, also known as NVM interface, is an NVM interface module configured to communicate or interface with NVM 210. In one aspect, flash interface 214 and Ethernet interface 212 are coupled in such a way that data can be efficiently transmitted between NVM 210 and a host system via connector 202.

CPU 222 is a digital processor capable of control various operations and functions provided by the SNS plug via execution of instruction. For example, CPU 222 assists controller 220 to perform various SSD operations, such as, but not limited to, storing data persistently, reading data, transmitting data, recycling storage space, and/or organizing storage space using FTL.

Initiator 224, also known as plug initiator, is coupled to CPU 222 and facilitates system reboot function via boot bios. Initiator 224, in one aspect, is responsible for monitoring handshaking process between the SNS plug and the host when the SNS plug is initially plugged into a port of host. The functions of hot plugging and hot unplugging are managed and/or assisted by initiator 224. The handshaking process is a process of negotiating and establishing various communication parameters and channel(s) between two devices such as a router and SNS plug when the two devices are initially connected. Hot plugging or hot unplugging which is also known as hot swapping is a process of replacing or adding components without stopping or shutting down the system with minimum interruption to the normal operation of the system.

Buffer 226, in one aspect, is volatile memory such as DRAM (dynamic random access memory) configured to buffer data during NVM memory access operation. A function of buffer is to enhance NVM efficiency by temporarily storing data before it is being written to NVM permanently.

Thermal module 228 is used to regulate thermal temperature or condition within the SNS plug. For example, thermal module 228 is able to dissipate heat through housing 204 of the SNS plug. The housing 204 can be fabricated with thermal conductive material such as aluminum. Note that the SNS plug can produce a large amount of heat depending on the type of NVM used. Alternatively, thermal module 228 can also shut down certain functions and/or modules in the SNS plug if thermal module 228 detects that the temperature in the SNS plug exceeds a predefined thermal limit. Also, thermal module 228 is configured to communicate with clock module 232 to adjust clock speed based on the thermal conditions. Clock module 232 generates cycles which are fed to other modules such as CPU 222.

Power module 230, in one embodiment, is able to provide power supply to various modules and NVM 210 using power supplied by the host via connector 202. For example, power module 230 is able to draw power from an SFP socket of host and redistributes the power to fulfill power requirements for the SNS plug. Depending on the type of NVM, different power consumption level may be required. It should be noted that several different types of NVM may be used in the SNS plug.

NVM, NVM chip, or NVM die 210, in one example, includes multiple flash based IC dies having a storage capacity between one (1) gigabytes (“GB”) and 64 terabytes (“TB”). NVM 210, in one aspect, is organized in planes, blocks, and pages based on SSD configuration. PCB 208 also includes extension 216 and LED (light emitting diode) module 218. LED module 218 is used to indicate the status of the plug while extension 216 is used to provide additional connections. In one aspect, extension 216 which can be circuit or component is configured to facilitate auxiliary interface or auxiliary connection.

The SNS plug or SAP, in one aspect, is an NVM SSD using Ethernet based protocol, such as NVMoE for providing additional data storage to existing apparatus via connectors such SFP and/or QSFP. For example, the SNS plug is configured and/or integrated into an SFP/QSFP form-factor whereby it can be directly plugged into a network switch fabric for providing multi-terabytes storage space. Depending on the applications, any types of volatile or nonvolatile media such as NAND Flash, DRAM, RRAM, MRAM, and the like can be used. For example, a 10-to-40 gigabits per second (“Gb/s”) Ethernet port in a switch may be occupied by an SNS plug configured in small form-factor to provide a terabyte storage space using Ethernet based protocol.

An advantage of using an SAP or SNS plug is that it provides additional storage space to an existing port at the host with minimum space requirement.

FIG. 2B illustrates a control SAP 250, memory SAP 252, and power SAP 256 wherein control SAP 250 contains a controller 260 used for control and manage one or more SAP(s) via extension connector 262 for MOM linkage. The connected SAP can be memory SAP, power SAP, control SAP, or SAP containing control, power, and memory units. Control SAP 250, in one example, includes a PCB 268 hosting extension connector 262, controller 260, and SFP connector 202. SFP 202 is used to couple to SFP socket contact(s) located at a host system. In one aspect, control SAP 250 contains minimal amount NVM storage capacity. It should be noted that the underlying concept of the exemplary embodiment(s) of the present invention would not change if one or more blocks (or modules) were added to or removed from FIG. 2B.

Memory SAP or SNS plug 252, in one embodiment, contains a PCB 278 housing multiple banks of NVM 270-272, extension or auxiliary connector 276, and SFP connector 202. A function of memory SAP 252 is to provide storage capacity. However, memory SAP 252, in one aspect, requires a MOM linkage to a control SAP for managing its NVM banks. MOM or POP linkage, in one example, is a cable configured to physically link two or more SAPs via the auxiliary or extension connectors.

Power SAP or SNS plug 256, in one embodiment, includes a PCB 288 housing an auxiliary or extension connector 286, power management 280, and SFP connector 202 wherein SFP connector 202, in one embodiment, is able to couple to a power outlet situated nearby the host system. For example, a power source on the back panel of the system or on the wall adjacent to the system. Power management 280 includes a flash interface 284 and Ethernet interface 282. Flash interface 284 is used to couple to other SAP for providing power via extension 286 as a secondary or auxiliary power supply.

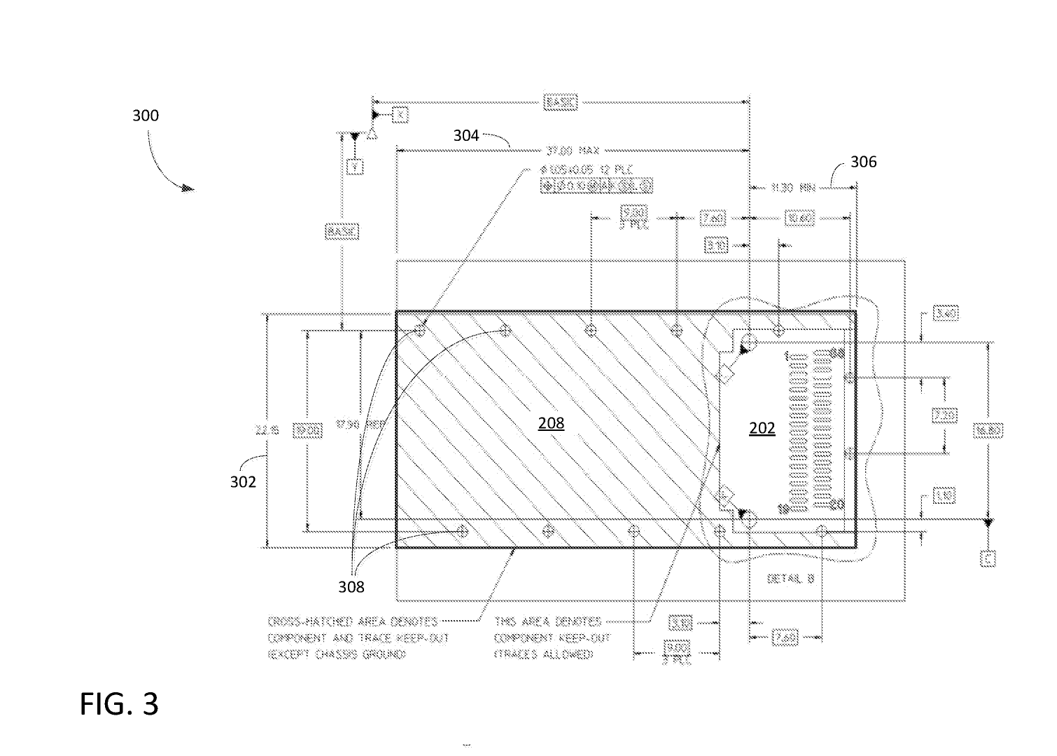

FIG. 3 is a diagram 300 illustrating a physical layout of PCB 208 for an SAP or SNS plug in accordance with one embodiment of the present invention. PCB 208 includes connector 202 and multiple anchoring holes 308. Diagram 300 illustrates an exemplary dimension for PCB 208. For example, the width of PCB 208 is 22.15 mm (millimeter) and the length of PCB 208 is 48.30 mm as indicated by numerals 304-306. It should be noted that the dimension for SFP is approximately 8.5 mm in height (“H”), 13.4 mm in width (“W”), and 56.5 mm in depth (“D”). While the approximate dimension for XSFP is 8.5 mm in H, 18.4 mm in W, and 78.0 mm in D, the approximate dimension for QSFP can be 13.5 mm in H, 18.4 mm in W, and 72.4 mm in D. It should be noted that the underlying concept of the exemplary embodiment(s) of the present invention would not change if one or more blocks (or measurements) were added to or removed from diagram 300.

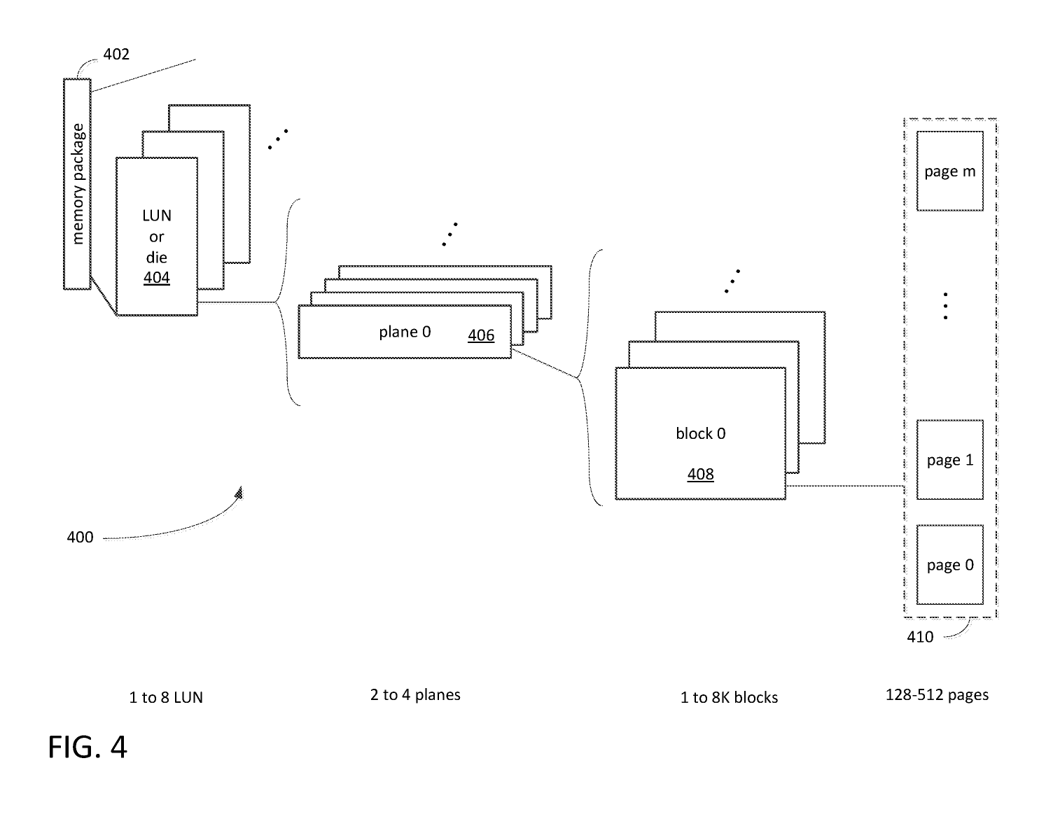

FIG. 4 is a block diagram illustrating a memory configuration for NVM within the SNS plug or SAP in accordance with one embodiment of the present invention. Diagram 400 includes a memory package 402 which can be a memory chip containing one or more NVM dies or logic units (“LUNs”) 404. A flash memory, for example, has a hierarchy of Package-Silicon Die/LUN-Plane-Block-Flash Memory Page-Word line configuration(s). It should be noted that the underlying concept of the exemplary embodiment(s) of the present invention would not change if one or more blocks (or devices) were added to or removed from diagram 400.

NVM memory device such as a flash memory package 402 contains one or more flash memory dies or LUNs wherein each LUN or die 404 is further organized into more NVM or flash memory planes 406. For example, die 404 may have a dual planes or quad planes. Each NVM or flash memory plane 406 can include multiple memory blocks or blocks. In one example, plane 406 can have a range of 1000 to 8000 blocks 408. Each block such as block 408 can have a range of 64 to 512 pages. For instance, a flash memory block can have 256 or 512 pages 410.

A flash memory page, for example, can have 8 KBytes or 16 KBytes of data plus extra redundant area for ECC parity data to be stored. One flash memory block is the minimum unit of erase. One flash memory page is the minimum unit of program. To avoid marking an entire flash memory block bad or defective which will lose anywhere from 256 to 512 flash memory pages, a page removal or decommission can be advantageous. It should be noted that 4 Megabytes (“MB”) to 16 MB of storage space can be saved to move from block decommissioning to page decommissioning.

Note that based on flash memory characteristics, a relatively small number of flash memory pages can usually be defective or become bad or unusable when the flash memory page PE (program erase) cycles, for example, are getting higher. For example, the bad page during program or read operation of that flash memory page can be discovered. A bad page can also be discovered if that page has much higher read errors during the normal read work load. A bad page can be further discovered when that page is bad and other pages in the same block are good.

SAP or SNS plug is configured in small form factor (“SFF”) connectors which offer high-speed, physical compactness, and the versatility of utilizing existing networking sockets for storage. For example, such SFF connectors are used by switches and routers for transmitting electrical as well as optical information. An advantage of using SAP is hot-swappable.

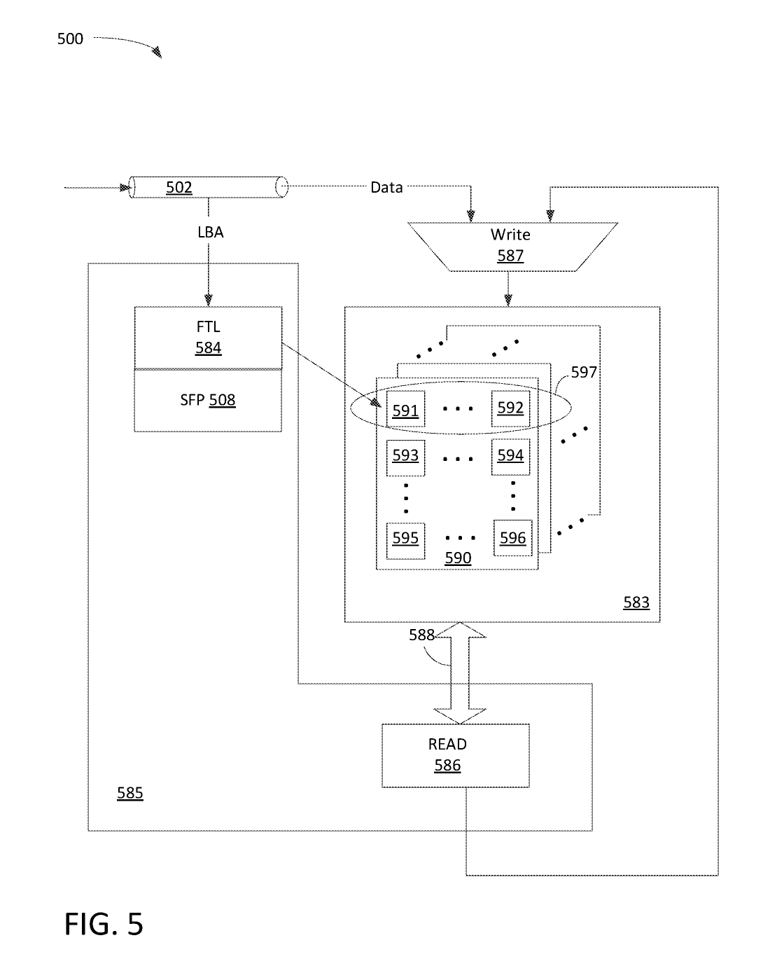

FIG. 5 is a logic block diagram illustrating an access to NVM storage space in an SNS plug or SAP via flash translation layer (“FTL”) in accordance with one embodiment of the present invention. Diagram 500 includes input data 502, storage device 583, output port 588, and storage controller 585. Storage controller 585 further includes read module 586, FTL 584, SFP module 508, and/or write module 587. A function of FTL 584 is, for example, to map LBA to physical address(s). It should be noted that the underlying concept of the exemplary embodiment(s) of the present invention would not change if one or more blocks (or devices) were added to or removed from diagram 500.

SFP module 508, which could be part of FTL 584, is configured to implement and/or facilitate SSD functions in the SNS plug. For example, SFP module 508 is responsible to communicate with host(s) using small form factor connection. Also, SFP module 508 facilitates the handshaking process between SNS plug and host upon initial connection.

Storage device 583, in one example, is flash based NVM containing multiple arrays of flash memory cells for storing data persistently. The flash memory, which generally has a read latency less than 200 microseconds (“μs”), is organized in blocks and pages wherein a minimum access unit, for example, can be set to four (4) kilobyte (“Kbyte”), eight (8) Kbyte, or sixteen (16) Kbyte memory capacity depending on the flash technologies. To simplify forgoing discussion, a four (4) Kbyte page or flash memory page (“FMP”) is used.

Referring back to FIG. 5, storage device 583 is organized into multiple NVM blocks 590 wherein each block such as block 590 further includes a set of pages or FMPs 591-596. Each page such as page 591 has a capacity or size capable of storing 4096 bytes or 4 Kbyte of information. Each block such as block 590, in one example, may contain a range of pages from 128 to 512 pages (or sectors) 591-596. A page, in one example, is generally a minimal writable or readable unit while a block is a minimal number to perform an erase function. Flash memory 583 can persistently retain information or data for a long period of time without power supply.

FTL 584, which may be implemented in DRAM, includes a FTL database or table that stores mapping information. For example, the size of FTL database is generally a positive proportion to the total storage capacity. For instance, one way to implement the FTL in SSD is that it uses a DRAM size that approximately equals to 1/1000 of SSD capacity. Since each page has a 4-Kbyte capacity and each entry of FTL database has a 4-byte capacity of entry, the size of FTL database can be calculated as SSD capacity/4 KByte*4 Byte (SSD capacity/1000) which is approximately 1 over 1000 (or 1/1000).

In operation, upon receipt of data input or data packets 502, FTL 584 maps LBA to physical page address (“PPA”) in storage device 583. After identifying PPA, write circuit 587 writes the data from data packets 582 to a page or pages within a block pointed by PPA. In one aspect, MNS 508 allocates or divides storage space into basic storage units wherein the storage capacities for the basic storage units are essentially the same or similar. Based on the incoming command, one or more basic storage units can be assigned or allocated to one NSID.

It should be noted that storage device 583 can also include NAND flash memory, NOR flash memory, phase change memory (“PCM”), nano random access memory (“NRAM”), magneto-resistive RAM (“MRAM”), resistive random-access memory (“RRAM”), programmable metallization cell (“PMC”), magnetic storage media (e.g., hard disk, tape), optical storage media, or the like. To simplify the forgoing discussion, the flash memory or flash memory based SSD is herein used as an exemplary NVM or NV storage device.

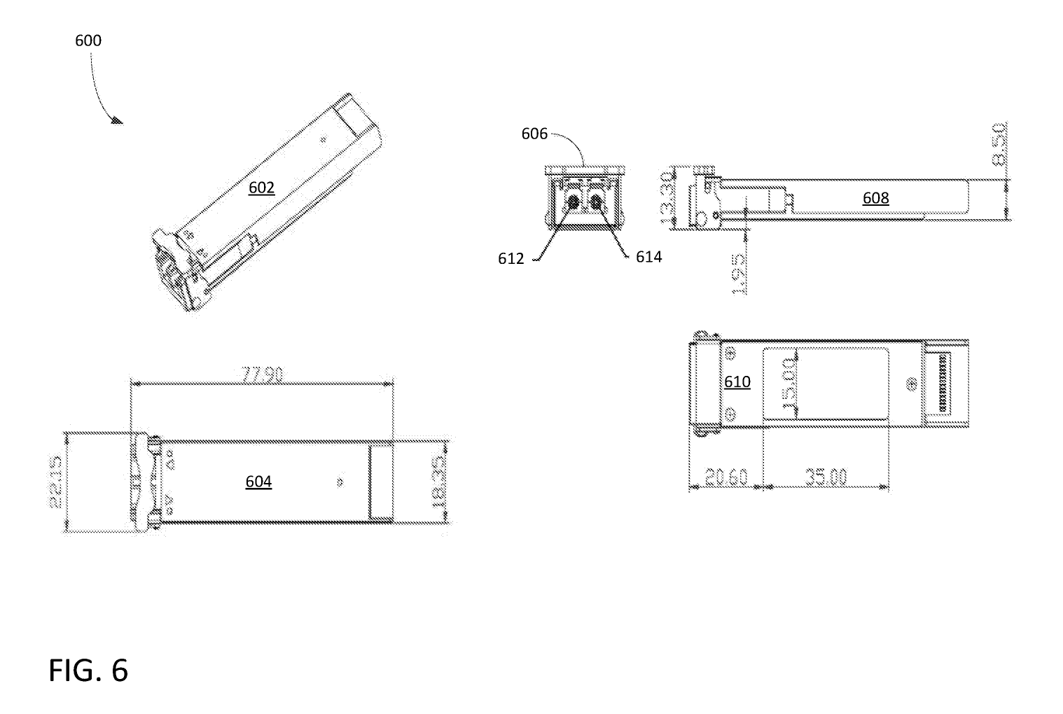

FIG. 6 illustrates an SNS plug 600 showing several structural diagrams 602-610 with an SFP and/or QSFP physical dimensions in accordance with one embodiment of the present invention. Diagram 602 illustrates a three dimensional (“3D”) structural diagram showing an SNS plug or SAP. Diagram 604 illustrates a top view of SNS plug with dimensions. Diagram 606 illustrates a back view of SNS plug containing two connectors 612-614 which can be used for extension of additional connections. Diagram 608 is a side view of SNS plug with dimensions. Diagram 610 is a top view of SNS plug with connectors. FIG. 6 shows different views of SFP or QSFP housings, cages, and/or sockets. It should be noted that the dimensions shown in FIG. 6 are for illustrative purposes. Any other dimensions with different configuration can be used to house SNS plug or SFP NVM storage device.

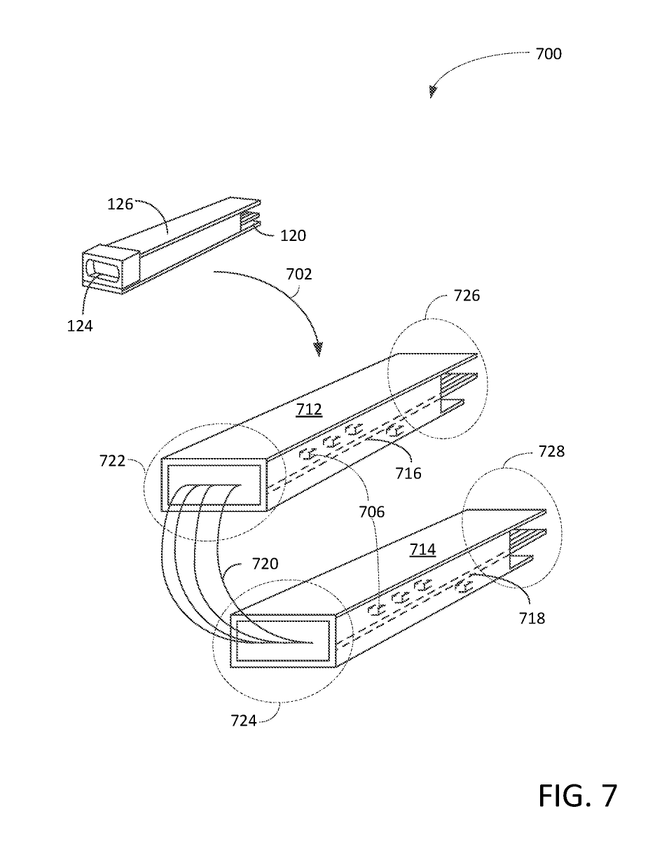

FIG. 7 is a block diagram 700 illustrating a physical layout of SAP or SNS plug capable of being coupled to a second SAP via one or more plug-to-plug or module-to-module linkages in accordance with one embodiment of the present invention. Diagram 700 illustrates SAP 712 as module A and SAP 714 as module B and they are capable of being working together via a plug-to-plug (“POP”) or module-to-module (“MOM”) cable 720. In one example, SAPs 712-714 are structured and configured similar to SAP 126 (described in FIG. 1) as indicated by arrow 702. It should be noted that the underlying concept of the exemplary embodiment(s) of the present invention would not change if one or more blocks (or components) were added to or removed from FIG. 7.

SAP 712 includes PCB 716, auxiliary connector 722, and SFP connector 726, wherein PCB 716 houses multiple chips or components 706. Chips 706 include, but not limited to, NVM dies, controller, power management, buffer, and/or the like. Similarly, SAP 714 includes a PCB 718, auxiliary connector 724, and SFP connector 728, wherein PCB 718 houses multiple chips or components 706. SFP connectors 726-728 of SAPs 712-714, in one example, are pluggable to SFP sockets or ports located at a system, not shown in FIG. 7. The system, in one example, can be a router, switch, modem, server, hub, et cetera. Alternatively, the system can also include QSFP sockets capable of receiving Quad-SAPs. It should be noted that SFP or QSFP based SAP can also be referred to as QSPF, SFP, SFP+ modules, devices, and/or plugs.

SAPs 712-714, in one example, are coupled or linked by an MOM or POP cable 720 via auxiliary connectors 722-724. SAP 712 is configured to supply power to neighboring SAP or SAPs such as SAP 714 via a flexible MOM cable 720. Alternatively, SAP 712 can supply additional memory capacity to SAP 714 or module B. In yet another embodiment, SAP 712 can be configured to provide memory control or management to SAP 714. Furthermore, SAP 712 can also be configured to supply power, storage, and/or control to SAP 714.

SAP 712, in one example, is a power delivery or secondary power supply plug wherein the physical dimension of SAP can be QSPF, SFP, or SFP+. For example, SAP 712 is an active QSPF containing SOC (system on chip), NAND Flash, and Power subsystem. The SOC can be referred to as ASIC (application-specific integrated circuit) chip configured to provide logic functions such as memory controller or system communication. SAP 714 as module B is a passive QSPF for providing extra storage capacity accessed by nearby or neighboring SAPs.

An advantage of using SAP is that it can manage per port power consumption associated with a connected switch or system. Also, SAP enhances overall system performance by supply additional high-speed storage capacity. Moreover, a power SAP is able to redistribute power to various connected SAPs by drawing power from one area of the plugged system and subsequently redistributing the power to nearby SAPs. Depending on the material of MOM cable 720, it can facilitate dissipating heat generated by SAP(s).

In one embodiment, an SAP or SNS plug such as SAP 712 or 714 is configured to provide high-speed storage, memory controller/management, status monitor, power consumption, power distribution, port management, or a combination of storage, control, monitor, and power management. To provide storage persistently, an SAP such as SAP 714 is configured to manage and store information using onboard NVM chips. In one aspect, the SAP includes a memory controller which is capable of managing various different types of NVM in one or more SAPs.

Alternatively, SAP 712 can be used to provide secondary power to SAP 714 for boosting power requirement associated with SAP 714 while keeping the power consumption at each port operating within predefined limits. It should be noted that power delivery from secondary SAP such as SAP 712 to primary SAP such as SAP 714 can be implemented using flexible PCB which is latched to both modules using connector plug & hold mechanism. In one embodiment, a power SAP also includes a power loss protection (“PLP”) circuit capable of providing backup power during unplanned power loss either due to module hot unplug or sudden power loss.

A control SAP such as SAP 712, in one example, is used to manage one or more nearby SAPs including, but not limited to, memory SAPs, power SAPs, and/or other control SAPs. The control SAP includes ASIC or SOC configured to provide memory control and/or management, and it is capable of performing data transfer to and from the storage device over native or non-native Ethernet implementation.

SAPs and MOM cables, in one embodiment, are used to manage thermal conditions. For example, an MOM cable such as cable 720 for power delivery may be coated with special heat dissipation material so that it can act as a heat sink. Heat generated within the active module can be dissipated via thermal contact and/or heat spreader tapes.

An advantage of using SAPs with MOM linkage is that it simplifies device connection by minimizing inter-module cablings whereby air flow between modules or plugs can be enhanced.

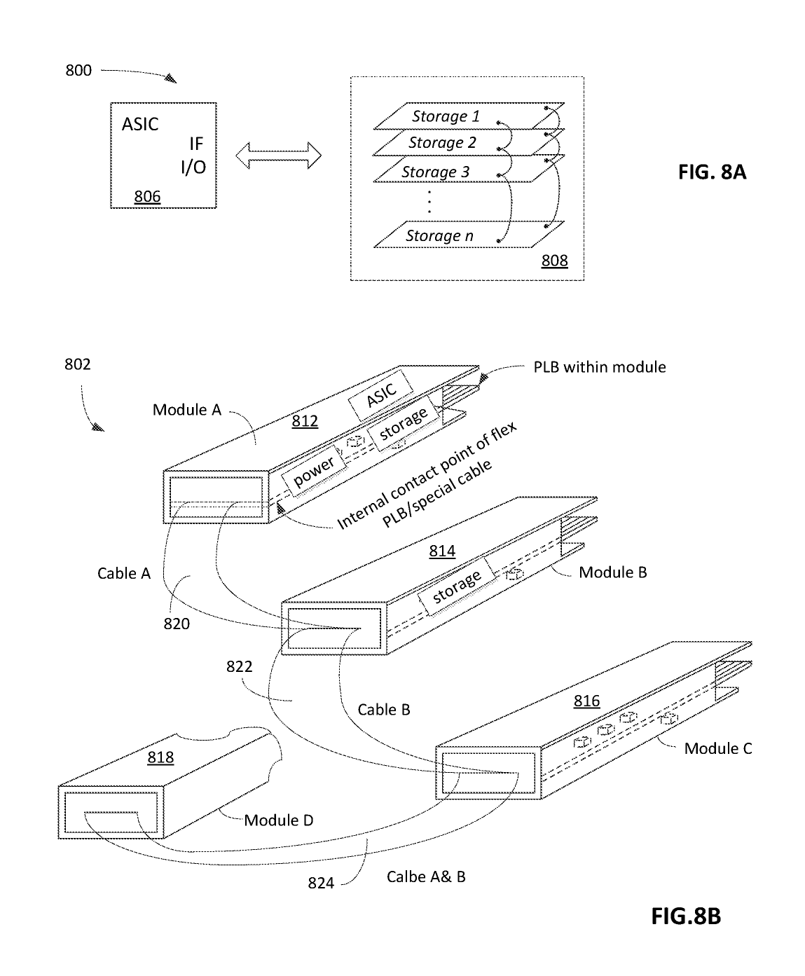

FIG. 8A is a block diagram 800 illustrating a memory controller 806 and storage component 808 configured or structured in a QSFP module, SAP, or SNS plug to enhance NVM storage performance in accordance with one embodiment of the present invention. Diagram 800 shows ASIC device 806 with I/O ports capable of communicating with multiple banks of storage memory or component 808. In one example, storage memory 808 is organized in multiple storage units such as storage 1, storage 2, storage 3, and storage n, wherein n is an integer. In one embodiment, storage 1 can be situated in an SAP which is capable of coupling to a system via SFP connectors or ports. Storage 1, 2, 3, and n which can be organized in one or more NVM dies are resided in one or more SAPs depending on the applications. Note that a single ASIC channel may be used to handle up to n storage dies connected to a single channel.

FIG. 8B is a block diagram 802 illustrating an alternative configuration to connect multiple modules or SAPs using MOM cables to enhance overall storage performance in accordance with one embodiment of the present invention. Diagram 802 includes four (4) SAPs 812-818 as module A through D, respectively. In one embodiment, modules A-D are linked by three (3) MOM cables 820-824 to enhance or expand capability of overall SAPs 812-818. It should be noted that the underlying concept of the exemplary embodiment(s) of the present invention would not change if one or more blocks (or modules) were added to or removed from diagram 802.

Module A, in one embodiment, is an active module containing ASIC, power subsystem, and primary flash device, while modules B/C/D are pseudo active module with secondary flash modules and power delivery. In one example, module A includes storage unit, control unit (ASIC), and power unit wherein its auxiliary connector couples to MOM cable 820 or cable A for power or storage expansion. Module B, in this example, is a memory SAP capable of providing additional storage capacity to the attached system. Module C, in one example, can be a power SAP capable of supplying power to module B and/or module D. It should be noted that the configuration of MOM linkage scheme addresses limitations of per module power consumption which allows obtaining additional power from neighboring SAPs or modules whereby a seamless expansion of storage can be achieved with neighboring as well as pseudo active modules/plugs.

Diagram 802 illustrates an interconnection configuration of SAPs to address storage expansion, directional expansion, and storage control. For example, modules can be near neighbors or far neighbors and layout in horizontal or vertical direction. The retime and redrive can be embedded on interconnect itself with latest fabrication and design technology. The communication between modules or SAPs can be master-slave configuration or a daisy chain format.

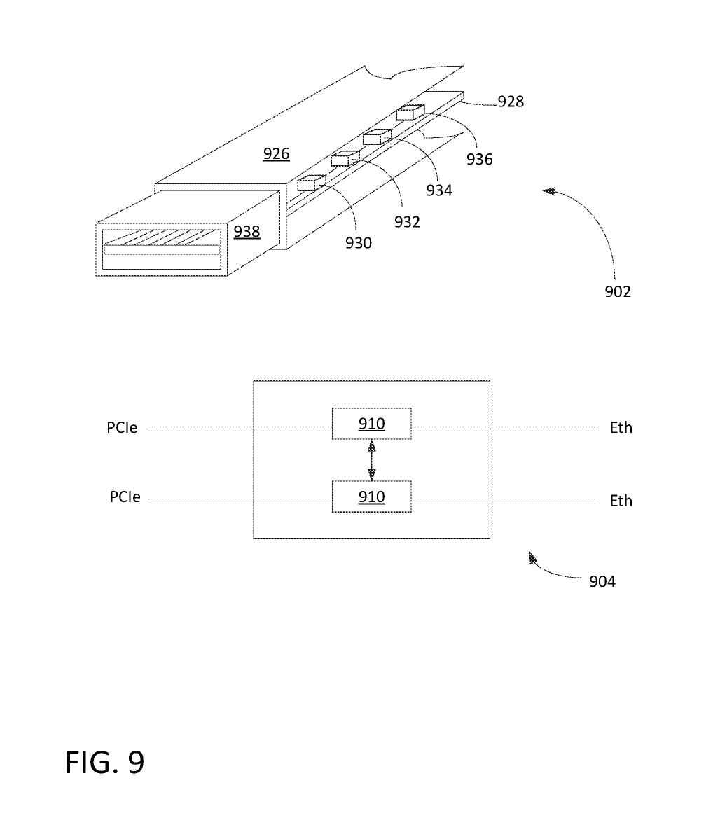

FIG. 9 illustrates an alternative exemplary storage device 902 using a different connector capable of coupling to an SFP auxiliary plug (“SAP”) for power or storage enhancement in accordance with one embodiment of the present invention. Storage device 902 uses a different auxiliary connector 938 capable of coupling to an SAP for power or storage enhancement. Storage device 926 includes a housing 926, auxiliary connector 938, and PCB 928 wherein PCB 928 further includes multiple circuitries 930-936. Circuitries 930-936 include, but not limited to, USB (universal serial bus) interface, Ethernet interface, ASIC controller, storage dies, and/or power chips. Connector 938, in one embodiment, uses ASIC with interface like USB 1/2/3, USBC, Thunderbolt, Fire Wire, etc. It should be noted that SAP 902 can be specifically configured to cover various different industrial coupling standards, such as PCIe, SATA, SAS, and the like.

FIG. 9 also illustrates an interface device 904 showing multiple ports with PCIe and Ethernet ports. In one aspect, device 904 is capable of providing sensors on storage module, such as temperature sensor, motion detection, GPS (global positioning system), and humidity sensors, for additional capabilities. Also, device 904 is able to provide operations relating to unexpected extraction to enable erasure/location or drive time, mechanical/external option to allow safe ejection of drive/theft protection, erase upon next power up id for unsafe ejection, external power supply, piggy back QSFP, secure erase button, and/or service and replace of plugged plug.

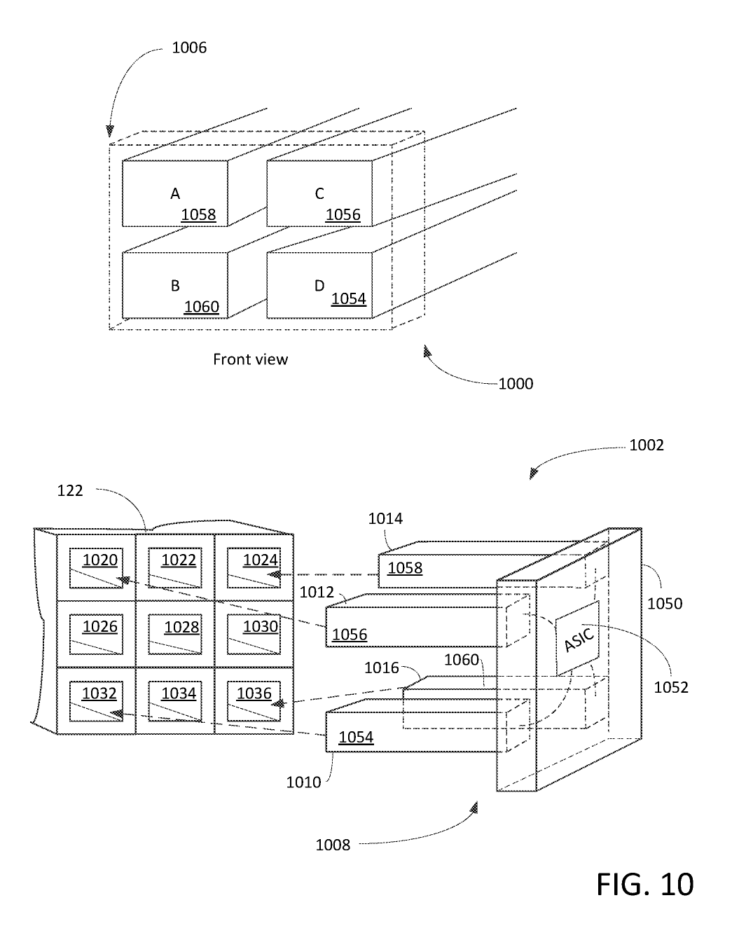

FIG. 10 illustrates diagrams 1000-1002 showing an alternative configuration using multiple-connected SAP module in accordance with one embodiment of the present invention. Diagram 1000 shows a front view of 4-SAP module containing four (4) SAPs 1054-1060 or modules A through D, respectively. The auxiliary connectors of SAPs 1054-1060 are coupled to a base module, not shown in diagram 1000. In one aspect, SAPs 1054-1060 or modules A through D are linked via the base block and SFP connectors of SAPs 1054-1060 are inserted into SFP sockets of system 1006 simultaneously.

Diagram 1002 is a 3D diagram of 4-SAP module 1008 which is similar to 4-SAP module illustrated in diagram 1000. Diagram 1002 includes 4-SAP module 1008 and digital processing system 122 wherein system 122 further includes 3-by-3 (nine) SFP sockets or ports 1020-1036. 4-SAP module 1008, in one embodiment, includes four SAPS 1054-1060 wherein the auxiliary connectors of SAP 1054-1060 are coupled to base module 1050. SFP connectors 1010-1016 of SAP 1054-1060 are configured to be pluggable to SFP sockets 1020, 1024, 1032, and 1036. It should be noted that base module 1052 can be reconfigured so that SFP connectors 1010-1016 can connect to any of the four of SFP sockets 1020-1036. Base module 1052, in one aspect, includes a memory controller situated in ASIC 1052. Base module 1050, in one embodiment, provides a linkage function capable of linking SAPs 1054-1060 to facilitate SAPs 1054-1060 working in concert to perform sophisticated tasks.

In one aspect, 4-SAP module 1008 is able to perform various different types of tasks, such as channel expansion, ports combining, power supply, memory control, and storage capacity. Channel Expansion on a switch device, for example, can increase throughput and performance of network communication. Combining ports can expand channels for enhancing device or module communication.

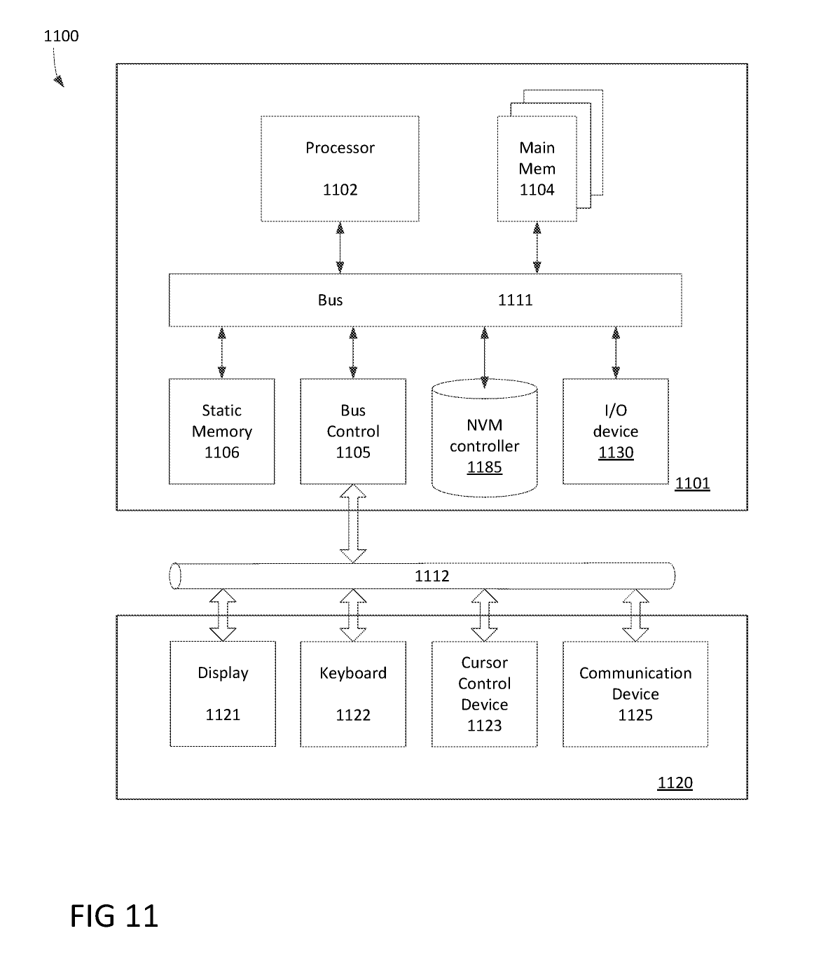

FIG. 11 is a block diagram illustrating a processing device or computer system which can be used as memory controller or network system in accordance with one embodiment of the present invention. Computer system or a signal separation system 1100 can include a processing unit 1101, an interface bus 1112, and an input/output (“IO”) unit 1120. Processing unit 1101 includes a processor 1102, a main memory 1104, a system bus 1111, a static memory device 1106, a bus control unit 1105, an I/O element 1130, and a NVM controller 1185. It should be noted that the underlying concept of the exemplary embodiment(s) of the present invention would not change if one or more blocks (circuit or elements) were added to or removed from FIG. 11.

Bus 1111 is used to transmit information between various components and processor 1102 for data processing. Processor 1102 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1104, which may include multiple levels of cache memories, stores frequently used data and instructions. Main memory 1104 may be RAM (random access memory), MRAM (magnetic RAM), or flash memory. Static memory 1106 may be a ROM (read-only memory), which is coupled to bus 1111, for storing static information and/or instructions. Bus control unit 1105 is coupled to buses 1111-1112 and controls which component, such as main memory 1104 or processor 1102, can use the bus. Bus control unit 1105 manages the communications between bus 1111 and bus 1112. Mass storage memory or SSD 106, which may be a magnetic disk, an optical disk, hard disk drive, floppy disk, CD-ROM, and/or flash memories are used for storing large amounts of data.

I/O unit 1120, in one embodiment, includes a display 1121, keyboard 1122, cursor control device 1123, and communication device 1125. Display device 1121 may be a liquid crystal device, cathode ray tube (“CRT”), touch-screen display, or other suitable display device. Display 1121 projects or displays images of a graphical planning board. Keyboard 1122 may be a conventional alphanumeric input device for communicating information between computer system 1100 and computer operator(s). Another type of user input device is cursor control device 1123, such as a conventional mouse, touch mouse, trackball, or other type of cursor for communicating information between system 1100 and user(s).

Communication device 1125 is coupled to bus 1111 for accessing information from remote computers or servers, such as server 104 or other computers, through wide-area network 102. Communication device 1125 may include a modem or a network interface device, or other similar devices that facilitate communication between computer 1100 and the network. Computer system 1100 may be coupled to a number of servers via a network infrastructure such as the Internet.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

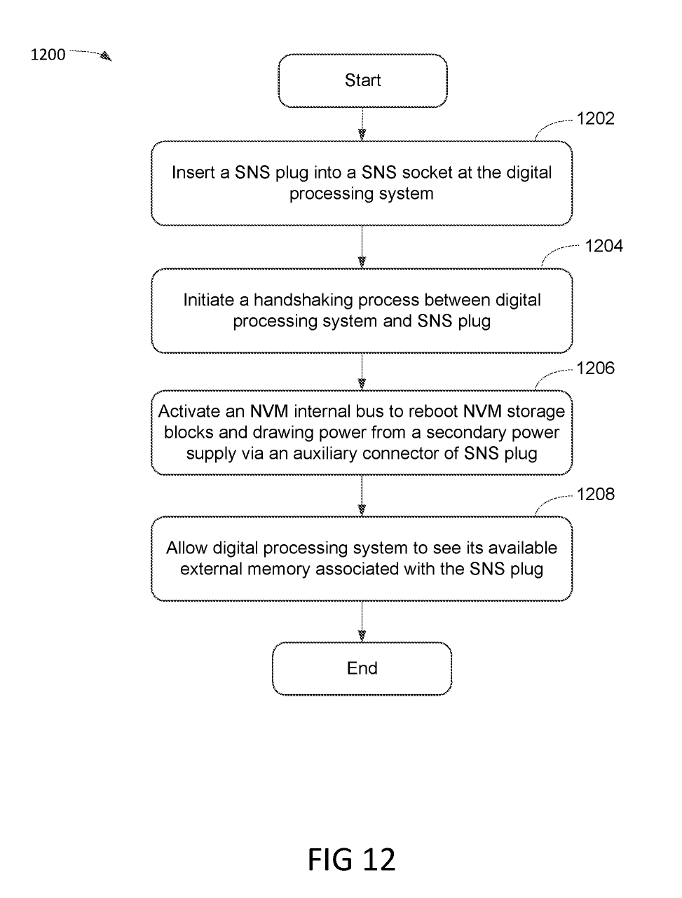

FIG. 12 is a flowchart 1200 illustrating a process of memory access to an SAP plug in accordance with one embodiment of the present invention. At block 1202, a process capable of providing a secondary power supply to an external storage pluggable to a digital processing system inserts an SNS plug or SAP into an SFP socket which is optical communication capable at a digital processing system. Before inserting the SNS plug, an SFP optical connector coupled to an optical fiber is pulled from the SFP socket.

At block 1204, a handshaking process between the digital processing system and the SNS plug is initiated using Ethernet based protocol.

At block 1206, an NVM internal bus connecting to NVM array is activated for rebooting NVM storage blocks and drawing power from a secondary power supply via an auxiliary connector of the SFP NVM SNS plug.

At block 1208, the digital processing system is able to see its available external memory associated with the SFP NVM SNS plug or SAP. In one embodiment, upon inserting a power SFP auxiliary plug into an SFP socket at a digital processing system for providing the secondary power supply, the process is able to draw power by the power SFP auxiliary plug from a power supply pin at the SFP socket for power redistribution to the SPF NVM SNS plug.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A system capable of storing data comprising:
a plurality of small form-factor (“SFP”) sockets situated at a processing device and operable to provide data communication;
a first SFP auxiliary plug (“SAP”) having a first solid state drive (“SSD”) connector and a first auxiliary connector, and configured to facilitate storing information persistently via non-volatile memory (“NVM”), wherein the first SSD connector is capable of communicating with the processing device when the first SAP is plugged into one of the plurality of SFP sockets; and
a power SAP, having a power connector and a power extension connector, configured to facilitate providing electrical power to the first SAP when the power extension connector and the first auxiliary connector are coupled.

2. The system of claim 1, further comprising a first cable configured to link between the power extension connector and the first auxiliary connector.

3. The system of claim 2, further comprising a second SAP, having a second SSD connector and a second auxiliary connector, configured to facilitate storing information persistently via NVM, wherein the second SSD connector is capable of communicating with one of the plurality of socket contacts when the second SAP is plugged into one of the plurality of SFP sockets.

4. The system of claim 3, further comprising a second cable configured to link between the power extension connector and the second auxiliary connector.

5. The system of claim 1, wherein the first SAP is configured to be pluggable into one of SFP and quad SFP (“QSFP”) sockets.

6. The system of claim 5, wherein the first SAP includes an NVM controller, SSD interface, NVM module, and auxiliary interface.

7. The system of claim 1, wherein the power SAP is configured to be pluggable into one of SFP and quad SFP (“QSFP”) sockets for providing power supply to at least one SAP.

8. The system of claim 2, wherein the first cable is structured with thermal conductive material configured to dissipate heat generated by the first SAP.

9. The system of claim 1, wherein the first SAP is fabricated with thermal conductive material capable of dissipating heat.

10. A system capable of storing data comprising:
a plurality of quad small form-factor (“QSFP”) sockets located at a network device operable to provide data communication via a plurality of socket contacts;
a first QSFP auxiliary plug (“QSAP”) having a first solid state drive (“SSD”) connector and a first auxiliary connector, and configured to facilitate storing information persistently via non-volatile memory (“NVM”), wherein the first SSD connector is capable of communicating with the network device when the first QSAP is inserted into one of the plurality of QSFP sockets; and
a power QSAP, have a power connector and a power auxiliary connector, configured to facilitate delivering electrical power to the first QSAP when the power extension connector and the first auxiliary connector are connected.

11. The system of claim 10, further comprising a first cable configured to link between the power extension connector and the first auxiliary connector.

12. The system of claim 11, further comprising a second QSAP, having a second SSD connector and a second auxiliary connector, configured to facilitate storing information persistently via NVM, wherein the second SSD connector is capable of communicating with one of the plurality of socket contacts when the second QSAP is plugged into one of the plurality of QSFP sockets.

13. The system of claim 12, further comprising a second cable configured to link between the power extension connector and the second auxiliary connector.

14. The system of claim 10, wherein the first QSAP includes an NVM controller, SSD connector, NVM module, and an auxiliary interface.

15. The system of claim 10, wherein the first QSAP provides additional storage capacity to the system.

16. The system of claim 10, further comprising a QSFP NVM SSD storage device containing multiple QSFP plugs configured to be pluggable to more than one QSFP socket concurrently to increase bandwidth of data communication.

18. A network system capable of storing data comprising:
a network switch capable of routing data and configured to have a plurality of small pluggable sockets for data communication;
a non-volatile memory (“NVM”) solid state drive (“SSD”) storage plug containing NVM cells, switch interface, auxiliary interface, and Ethernet capable communication module, and configured to be pluggable into one of the plurality of small pluggable sockets for providing additional storage capacity to the network switch; and
a controller plug containing NVM control component capable of facilitating storage management to the NVM cells of the NVM SSD storage plug when both the NVMSSD storage plug and the controller plug are plugged to the plurality of small pluggable sockets.

19. The system of claim 18,
wherein the plurality of small pluggable sockets are small form-factor pluggable (“SFP”) sockets;
wherein the NVM SSD storage plug is an SFP auxiliary plug (“SAP”); and
wherein the controller plug is an SFP plug.

20. The system of claim 19, further comprising a power SAP, having a power connector and a power extension connector, configured to facilitate distributing electrical power to the NVM SSD storage plug and the controller plug when the power SAP, the NVM SSD storage plug, and the controller plug are coupled to the plurality of SFP sockets.

21. The system of claim 20, further comprising a first cable coupled between the power SAP and the NVM SSD storage plug for providing power from the power SAP to the NVM SSD storage plug.

22. The system of claim 21, further comprising a second cable coupled between the power SAP and the controller plug for providing power from the power SAP to the NVM SSD storage plug.

23. The system of claim 18,
wherein the plurality of small pluggable sockets are quad small form-factor pluggable (“QSFP”) sockets;
wherein the NVM SSD storage plug is a QSFP auxiliary plug (“QSAP”); and
wherein the controller plug is a QSFP plug.

24. The system of claim 23, further comprising a power QSAP, having a power connector and a power extension connector, configured to facilitate distributing electrical power to the NVM SSD storage plug and the controller plug when the power QSAP, the NVM SSD storage plug, and the controller plug are coupled to the plurality of SFP sockets.

25. The system of claim 24, further comprising:
a first cable coupled between the power QSAP and the NVMSSD storage plug for providing power from the power QSAP to the NVMSSD storage plug; and
a second cable coupled between the power QSAP and the controller plug for providing power from the power QSAP to the NVMSSD storage plug.

26. The system of claim 18, wherein the NVM SSD storage plug is fabricated with thermal conductive material capable of dissipating heat.

27. A method for providing secondary power supply to an external storage pluggable to a digital processing system, comprising:
inserting a small form-factor pluggable (“SFP”) non-volatile memory (“NVM”) storage (“SNS”) plug into an SFP socket which is optical communication capable at a digital processing system;
initiating a handshaking process between the digital processing system and the SNS plug utilizing an Ethernet based protocol;
activating an NVM internal bus connecting to NVM array to reboot a plurality of NVM storage blocks and drawing power from a secondary power supply via an auxiliary connector of the SFP NVM SNS plug; and
allowing the digital processing system to see its available external memory associated with the SFP NVM SNS plug.

28. The method of claim 27, wherein inserting the SNS plug into the SFP socket further includes pulling an SFP optical connector coupled to an optical fiber from the SFP socket.

29. The method of claim 27, further comprising inserting a power SFP auxiliary plug into an SFP socket at a digital processing system for providing the secondary power supply.

30. The method of claim 29, further comprising drawing power by the power SFP auxiliary plug from a power supply pin at the SFP socket for power redistribution to the SNS plug.
